(19) United States
(12) Patent Application Publication
(10) Pub. No.: US 2006/0256947 A1
(43) Pub. Date: Nov. 16, 2006

(54) PBX-module capable of transmitting network signal

(76) Inventor: Ying-Lieh Huang, Putze City (TW)

Correspondence Address: PRO-TECHTOR INTERNATIONAL SERVICES, 20775 NORADA CT., SARATOGA, CA, 95070, US

(21) Appl. No.: 11/130,852

(22) Filed: May 16, 2005

(51) Int. Cl. H04M 7/00

(52) U.S. Cl. 379/219

(57) ABSTRACT

A PBX (Private Branch Exchange) module is disclosed to include an OFDM carrier module, a voltage isolation unit electrically connected to the OFDM carrier module for isolating voltage to let signal pass, a high-pass filter unit formed of a plurality of high-pass filter circuits electrically connected to the voltage isolation unit each having a predetermined high-pass filter value for allowing a high frequency signal over the predetermined high-pass filter value to pass and a connector connected to a respective telephone set, and a low-pass filter unit formed of a plurality of low-pass filter circuits electrically connected to the high-pass filter circuit each having a predetermined low-pass filter value for allowing a low frequency signal below the predetermined low-pass filter value to pass and a connector connected to a private branch exchanger.

### BACKGROUND OF THE INVENTION

1. Field of the Invention

The present invention relates to a PBX-module (Private Branch Exchange module) and more particularly, to such a PBX-module, which employs an OFDM (Orthogonal Frequency Division Multiplexing) subject to a single-input to multi-output architecture to achieve transmission of network signal.

2. Description of the Related Art

Conventional buildings commonly have a telephone piping system for the arrangement of the telephone lines of a telephone system. However, for establishing an Internet environment in a building, a network line system must be separately constructed. Because this network line system cannot be hidden in the telephone piping system of the building, it obstructs the sense of internal beauty of the building. A wireless network system is free from the arrangement of wiring; however, it has the problem of dead angle and limited receiving angle. Further, when a wireless network system is used in a multi-floor building, a wireless transmitter must be installed in every floor of the building. The installation of wireless transmitters in a building is a complicated work.

In order to overcome the problems encountered in the arrangement of network lines, network technologies such as HomePlug and HomePNA have been developed. These network technologies use the existing power lines or telephone lines for transmitting network data signal. However, these technologies have the common drawback of high installation cost.

Therefore, it is desirable to provide a measure that eliminates the aforesaid problems.

### SUMMARY OF THE INVENTION

The present invention has been accomplished under the circumstances in view.

It is therefore the main object of the present invention to provide a PBX-module, which enables every end-user to connect to the Internet through the existing telephone line, thereby saving much network wire installation cost and installation inconvenience.

To achieve this and other objects of the present invention, the PBX-module comprises include an OFDM carrier module, a voltage isolation unit electrically connected to the OFDM carrier module for isolating voltage to let signal pass, a high-pass filter unit formed of a plurality of high-pass filter circuits electrically connected to the voltage isolation unit each having a predetermined high-pass filter value for allowing a high frequency signal over the predetermined high-pass filter value to pass and a connector (such as RJ-11 connector) connected to a respective telephone set, and a low-pass filter unit formed of a plurality of low-pass filter circuits electrically connected to the high-pass filter circuit each having a predetermined low-pass filter value for allowing a low frequency signal below the predetermined low-pass filter value to pass and a connector (such as RJ-11 connector) connected to a private branch exchanger.

### BRIEF DESCRIPTION OF THE DRAWING

FIG. 1 shows the system architecture of the present invention.

### DETAILED DESCRIPTION OF THE PREFERRED EMBODIMENT

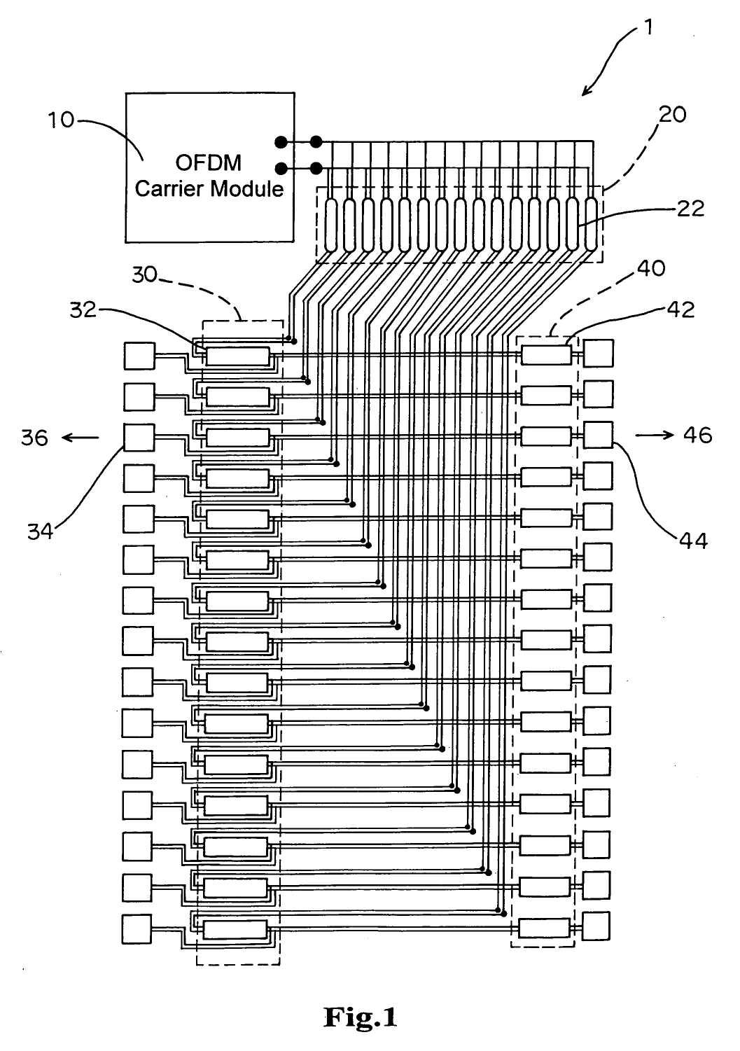

Referring to FIG. 1, a PBX-module 1 in accordance with the present invention is shown comprised of an OFDM carrier module 10, a voltage isolation unit 20, a high-pass filter unit 30, and a low-pass filter unit 40.

The OFDM carrier module 10 employs a multi-carrier modulation technology to increase the bandwidth, reduce interference, enhance encryption, and eliminate the communication problem of multi-path attenuation.

The voltage isolation unit 20 is electrically connected to the OFDM carrier module 10 and adapted to execute the desired isolation subject to the number of lines connected to the network. According to this embodiment, the voltage isolation unit 20 is comprised of at least one voltage isolation circuit 22 adapted to isolate the unnecessary voltage and/or current, allowing only signal to pass.

The high-pass filter unit 30 is electrically connected to the voltage isolation unit 20, comprising at least one high-pass filter circuit 32 in match with the at least one voltage isolation circuit 22. Each high-pass filter circuit 32 has a predetermined high-pass filter value for allowing high frequency signal over the predetermined high-pass filter value to pass. Each high-pass filter circuit 32 further has the output side provided with a connector 34 (such as: RJ-11 connector) for the connection of a telephone set 36.

The low-pass filter unit 40 is electrically connected to the high-pass filter unit 30, comprising at least one low-pass filter circuit 42 in match with the at least one high-pass filter circuit 32. Each low-pass filter circuit 42 has a predetermined low-pass filter value for allowing low frequency signal blow the predetermined low-pass filter value to pass. Each low-pass filter circuit 42 is provided with a connector 44 (such as: RJ-11 connector) for connection to the private branch exchanger 46.

By means of the high-pass filter unit 30, the invention prevents signal interference due to overlap with the private branch exchange. Therefore, the invention has the following advantages:

1. According to actual practice, every private company or government organization uses a private branch exchanger for communication with other parties, and every user has a telephone branch, i.e., a physical telephone line exists between every telephone branch and the private branch exchanger. This physical telephone line can be used in the present invention for transmission of network signal.

2. The invention increases the transmission function of each telephone line of the private branch exchanger, i.e., enables each telephone line to have the transmission function of a network line. When a private branch exchanger (which has the characteristic of single-input and multi-output) is provided with a PBX-module of the present invention, all the telephone lines of the private branch exchanger have OFDM carrier signal, and network data signal can be discriminated and transmitted to the assigned telephone branch and every telephone branch user can connect to the Internet without affecting the communication quality of the private branch exchanger.

3. By means of the PBX-module, an enterprise can use the existing telephone lines to connect to the Internet, thereby saving much expense on wiring.

Although a particular embodiment of the invention has been described in detail for purposes of illustration, various modifications and enhancements may be made without departing from the spirit and scope of the invention.

What the invention claimed is:

1. A PBX (Private Branch Exchange) module comprising:
an OFDM carrier module;
a voltage isolation unit electrically connected to said OFDM carrier module adapted to isolate voltage for letting signal pass;
a high-pass filter unit electrically connected to said voltage isolation unit, said high-pass filter unit comprising at least one high-pass filter circuit having a predetermined high-pass filter value for allowing a high frequency signal over the predetermined high-pass filter value to pass; and
a low-pass filter unit electrically connected to said high-pass filter unit, said low-pass filter unit comprising at least one low-pass filter circuit having a predetermined low-pass filter value for allowing a low frequency signal below said predetermined low-pass filter value to pass.

2. The PBX module as claimed in claim 1, wherein said high-pass filter unit has a connector connected to a telephone set for letting a high frequency signal passed therethrough pass to the connected telephone set.

3. The PBX module as claimed in claim 1, wherein said low-pass filter unit has a connector connected to a private branch exchanger for letting a low frequency signal passed therethrough to pass to the connected private branch exchanger.

4. A PBX (Private Branch Exchange) module comprising:
an OFDM carrier module;
a voltage isolation unit electrically connected to said OFDM carrier module, said voltage isolation unit comprising a plurality of voltage isolation circuits adapted to isolate voltage for letting signal pass;
a high-pass filter unit, said high-pass filter unit comprising a plurality of high-pass filter circuits respectively electrically connected to said voltage isolation circuits and having a predetermined high-pass filter value for allowing a high frequency signal over the predetermined high-pass filter value to pass; and
a low-pass filter unit electrically connected to said high-pass filter unit for receiving signal passed through said high-pass filter unit, said low-pass filter unit comprising a plurality of low-pass filter circuits respectively electrically connected to said high-pass filter circuits and having a predetermined low-pass filter value for allowing a low frequency signal below said predetermined low-pass filter value to pass.

5. The PBX module as claimed in claim 4, wherein each high-pass filter circuit of said high-pass filter unit has a connector connected to a telephone set for letting a high frequency signal passed therethrough pass to the connected telephone set.

6. The PBX module as claimed in claim 4, wherein each low-pass filter circuit of said low-pass filter unit has a connector connected to a private branch exchanger for letting a low frequency signal passed therethrough to pass to the connected private branch exchanger.
